(19) United States
(12) Patent Application Publication
(10) Pub. No.: US 2012/0170088 A1
(43) Pub. Date: Jul. 5, 2012

(54) MEMS Spatial Light Modulator Driver Calibration Systems

(76) Inventors: Ion E. Opris, San Jose, CA (US); Vlad Novotny, Los Gatos, CA (US); Paul Richard Routley, Longstaton (GB)

(21) Appl. No.: 12/983,197

(22) Filed: Dec. 31, 2010

(51) Int. Cl. G02B 26/00; G03H 1/08

(52) U.S. Cl. 359/9; 359/291

(57) ABSTRACT

We describe a method of compensating for long-term mechanical property changes in an analogue optical MEMS SLM. In embodiments the SLM comprises multiple piston-type actuation optical phase modulating pixels each having a mirror with a variable height determined by an analogue voltage applied to a corresponding pixel electrode. The method comprises performing initial calibrations of the analogue displacement and pixel capacitance versus analogue voltage to determine a relationship between the pixel capacitance and analogue displacement, and then updating the displacement-voltage capacitance using the initial calibration data and a later calibration of the analogue voltage-capacitance characteristic of a pixel.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2010, Light Blue Optics Inc.

### BACKGROUND

1. Field

Embodiments of the present invention relate generally relate to techniques for compensating for long-term mechanical property changes in an analogue optical MEMS (micro electromechanical system) SLM (spatial light modulator), and to holographic image display systems incorporating such techniques.

2. Description of the Related Art

We have previously described various holographic image projection systems (see, for example, WO2007/141567), and more recently a holographic projector in which, broadly speaking, a holographically generated image is used for illumination of a second spatial light modulator (see, for example, WO2010/007404 and U.S. Ser. No. 12/182,095, which is hereby incorporated by reference in its entirety for all purposes). In this latter approach relatively low resolution phase modulation is employed to render lower spatial frequencies of an image holographically, the higher frequency components being rendered with an intensity modulating imaging panel placed in a plane conjugate to the hologram SLM. In such a system the hologram is preferably a fast, multiphase or quasi analogue-phase device, more particularly a pixellated MEMS (micro electromechanical system)—based piston actuated device.

There are special requirements for the pixel driver circuits of an analogue MEMS SLM in which the mirror may be moved by a variable analogue displacement corresponding to a variable analogue voltage applied to a pixel electrode of the device. In particular because an analogue voltage drive is employed it is desirable to achieve good linearity. In a device with piston-type mirror actuation the nature of the spring mount introduces further special considerations.

In a diffractive, in particular holographic, image display system accurate and repeatable control of the pixel mirror motion is also important, and this imposes tight constraints on motion control—for example for five bit resolution at approximately 400 nm the phase steps may be less than 15 nm or less than 10 nm apart, for example at intervals of around 8 nm.

In a diffractive image projection system it is also desirable that the lateral dimensions of individual pixels should be small, because this increases diffraction angles from the SLM. For example preferably a pixel should be less than 30 μm by 20 μm. However this can introduce further difficulties, because of the very small charges which are then present on the pixel electrodes.

We will describe techniques for compensating for long-term mechanical property changes in an analogue optical MEMS SLM, in particular a phase modulating SLM, which take account of these special difficulties, including the need for an accurate and controllable analogue variable mirror position.

### SUMMARY

According to a first aspect of the invention there is therefore provided a method of compensating for long-term mechanical property changes in an analogue optical MEMS SLM, wherein said SLM comprises a plurality of optical phase modulating pixels each comprising a mirror having a variable displacement determined by an analogue voltage applied to a pixel electrode of the pixel, the method comprising: performing a first initial calibration, for each said pixel of said SLM, of the analogue displacement of said mirror resulting from a said analogue voltage applied to the pixel; performing a second initial calibration, for each said pixel of said SLM, of a capacitance of said pixel electrode of the pixel resulting from a said analogue voltage applied to the pixel; performing at least one later calibration after said first and second initial calibrations, for each said pixel of the SLM, of the capacitance of said pixel electrode of the pixel resulting from a said analogue voltage applied to the pixel; updating, for each said pixel of said SLM, said calibration of said analogue displacement of said mirror resulting from said applied analogue voltage using said later calibration of said capacitance resulting from said applied analogue voltage; and using said updated calibration to determine an optical phase modulation drive to said pixels of said SLM to compensate for said long-term mechanical property changes.

Broadly speaking in embodiments of this method a substantially constant over time relationship is assumed to exist between the capacitance of the MEMS pixel (electrode) and the displacement of the mirror. More particularly, the relationship is between the capacitance and the distance between the driven pixel electrode and the second, moving pixel electrode (which, in embodiments, is attached to the mirror). The skilled person will appreciate that measuring/calibrating the displacement of the mirror corresponds to measuring/calibrating the distance between the two pixel electrodes.

Thus in embodiments of the method the capacitance-distance or capacitance-displacement characteristic is assumed to be an inherent property of the MEMS pixel. In reality this is not precisely the case since the capacitance is not just a function of the distance between the electrodes, but is also a function of mirror tip/tilt (even in a piston-type MEMS pixel these may vary slightly over time), mirror radius curvature (although in embodiments a mirror is substantially flat), and any changes in the relative permittivity of the space between the electrodes (although in embodiments the device is hermetically sealed) and so forth. Nonetheless the assumption is useful.

Once the initial calibrations of distance/displacement against analogue voltage and capacitance against analogue voltage have been made, a later measurement or calibration of the capacitance-voltage characteristic of a MEMS pixel, more particularly of each pixel of the SLM, can be used in combination with an initial, inferred capacitance-distance/displacement characteristic to determine an updated distance/displacement-voltage characteristic for the/each MEMS pixel. This can then be employed, for example, for determining the voltage to be applied to the/each pixel in an optical phase modulating SLM to define precisely the desired translation of the mirror to achieve a desired optical phase shift.

In embodiments the method is applied particularly to a MEMS SLM device in which the pixel mirrors have a piston-type actuation, because the assumption of a constant capacitance-distance/displacement relationship is particularly appropriate and apt for such devices.

Thus, broadly speaking, in embodiments of the above described method capacitive sensing is employed to provide closed loop analogue voltage position feedback in an optical MEMS SLM, in particular of the type employing piston-type mirror actuation (in which the mirror moves perpendicularly to the substrate substantially without tilting).

In some preferred implementations of the above-described method, measurement circuitry and non-volatile memory are both provided on the SLM. The measurement circuitry is configured to determine the updated calibration of capacitance versus distance/displacement. The non-volatile memory stores data derived from the updated calibration for use in driving the pixels of the SLM to compensate for mechanical property changes of the pixels, for example caused by spring fatigue and the like.

Incorporating the measurement circuitry onto the SLM is particularly advantageous where the pixels are physically small, for example as desirable for a diffractive image generation system. This is because where the pixels are small there may only be a very small charge on a pixel electrode, and thus to reduce the time taken to obtain a valid measurement it is desirable to have short track lengths between the measurement circuitry and the pixels. The data stored in the non-volatile memory may, in embodiments, comprise a relatively small number of parameters for each pixel, for example less than 5 parameters, in embodiments just two parameters or even a single parameter. This is because, in embodiments, it is possible to approximate the (voltage) response of a pixel by a curve which can be characterised by such a small number of parameters. In embodiments the updated analogue variable displacement calibration may have better than a 50 nm, 40 nm, 30 nm, 20 nm or 10 nm standard deviation displacement error.

In embodiments the determining of the updated calibration may employ measurement circuitry which drives a MEMS pixel with a waveform, in particular a square/pulse waveform, using opposite phases of the waveform to add and subtract charge to/from the pixel electrode. In this way the circuit can measure the charge on the pixel against the charge on a reference capacitor comprising part of the measurement circuit. Balancing the charge in this way, in particular over a large number of cycles—for example greater than 10², 10³, 10⁴ or 10⁵ cycles—enables the unknown pixel capacitance to be determined as a proportion of the reference capacitance. This can be done by counting the proportion of the total number of cycles in which charge is added as compared with those in which charge is subtracted (from the measured, pixel capacitance). The baseline or ‘zero’ level of the applied voltage waveform may be varied to vary the voltage at which the capacitance is determined.

An approach of this type is advantageous as it enables very small charges to be measured—the desired limit of measurement may correspond to less than 10 electrons RMS (root mean square), although a less precise measurement may be used, for example, to determine whether or not a pixel is stuck. Embodiments of the techniques we describe can achieve this, measuring over a period of 1-1000 ms, in embodiments around 10 ms.

In embodiments, when determining an analogue voltage to apply to a pixel electrode an input displacement or phase value may be used in conjunction with the stored calibration data to determine an analogue voltage to apply. However in embodiments of the SLM a pixel may be driven by the output of a relatively low resolution digital-to-analogue converter, for example having, say, 5, 6, 7 or 8 bits. The input data phase or displacement to the SLM may be of higher resolution, for example 8 or 16 bit digital data. In such a case a translation may be applied to the input data by identifying, for example from the stored calibration data, the closest analogue voltage to those representable by the digital-to-analogue converter(s). If the input phase data has more bits than the on-chip digital-to-analogue converter(s) the input digital data may be mapped to the reduced number of bits employed by the D/A converter(s) by mapping the target analogue voltage for a pixel to the nearest D/A quantised digital value available from the output of the, say, 6 bit D/A converter.

In embodiments a D/A converter may itself implement a non-linear conversion, that is the output analogue voltage from the D/A converter may not be a linear function of the input digital value because the D/A converter may compensate for inherent non-linearity in the displacement/distance-voltage response of a MEMS pixel mirror. This may be achieved, for example, by employing a D/A converter of the type having taps on a resistor string, and positioning the taps at non-equal spacings to achieve a non-linear mapping of digital input value-to-analogue voltage. In this way the on-chip D/A converter may provide a substantially linear displacement of the pixel mirror in response to a digital value applied to this D/A converter, the calibration then applying residual corrections to this response. In embodiments this correction may be achieved by providing on-chip on the SLM, a table which stores target analogue voltage values for each of the MEMS SLM pixels.

The voltage-distance/displacement response of a MEMS SLM pixel in general also has some temperature dependence, and in embodiments the SLM substrate incorporates temperature measurement circuitry. A temperature value determined by this circuitry may be employed to adjust the distance/displacement versus voltage characteristic to compensate for temperature variations. This may be achieved, for example, by selecting one of a set of stored calibration parameters for the MEMS pixel array depending upon a temperature range at which the device is determined to be operating, and/or a stored parameter value or values may be scaled using the temperature value.

The above described techniques are particularly advantageous when used in the context of a diffractive or holographic image display system. In such a system, because of the relatively small pixel size and there can be a relatively long measurement time. Therefore in embodiments of the method the diffractive/holographic display system is configured to update the capacitance-voltage calibration whilst the image display system is in a standby operation mode. In this way calibration is performed automatically and as a background task, potentially just one or a few pixels at a time. Thus the system can automatically remain in calibration over time without seeming to the user to require any long calibration process. A diffractive/holographic display system employing a MEMS SLM of the type described may remain substantially in calibration throughout 10s or 100s of hours of use, by a process which is substantially transparent to a user.

In a related aspect the invention provides an analogue optical MEMS spatial light modulator (SLM) comprising a substrate bearing plurality of optical phase modulating pixels, each of said phase modulating pixels comprising a pixel electrode and a mirror mounted on a hinge or spring to provide an analogue variable displacement in response to an analogue voltage applied to said pixel electrode with respect to a common electrode of said pixel, wherein said SLM further comprises measurement circuitry fabricated on said substrate and having a drive output configured to apply a signal to one of said pixel electrode and said common electrode, having an input to receive a signal from one of said pixel electrode and said common electrode, and having a pixel measurement output responsive to said analogue variable displacement.

In a still further aspect the invention provides a method of compensating for long-term mechanical property changes in a diffractive image display using an analogue optical MEMS spatial light modulator (SLM), said MEMS SLM comprising a substrate bearing a plurality of optical phase modulating pixels, each of said phase modulating pixels comprising a pixel electrode and a mirror mounted on a hinge or spring to provide an analogue variable displacement in response to an analogue voltage applied to said pixel electrode; the method comprising: performing an initial calibration of said SLM to determine a relationship between an analogue voltage applied to a said pixel electrode and said analogue variable displacement; displaying a plurality of diffraction patterns on said SLM to diffractively display a plurality of images; performing a further calibration of said SLM to update said relationship between said analogue voltage applied to a said pixel electrode and said analogue variable displacement; and displaying a further plurality of diffraction patterns on said SLM to diffractively display a further plurality of images using said updated relationship between said analogue voltage applied to a said pixel electrode and said analogue variable displacement.

### BRIEF DESCRIPTION OF THE DRAWINGS

These and other aspects of the invention will now be further described, by way of example only, with reference to the accompanying figures in which:

FIG. 1 shows a 3D perspective view, with cutaway portions, of a portion of an optical phase modulating MEMS SLM;

FIG. 2 shows an example of a holographic image projection system in which the MEMS SLM of FIG. 1 may be employed;

FIGS. 3a and 3b show, respectively, example mirror deflection-voltage relationships for a MEMS pixel structure of the type shown in FIG. 1, and a model of a MEMS pixel in the structure of FIG. 1;

FIGS. 4a and 4b show, respectively, a calibration process for an analogue optical MEMS SLM according to an embodiment of the invention, and a schematic illustration of the process;

FIG. 5 shows a portion of a holographic image display system incorporating an analogue optical MEMS spatial light modulator configured to implement the process of FIG. 4a;

FIG. 6 shows an embodiment of a pixel capacitance measurement circuit for measuring capacitance as a function of voltage, for use in the system of FIG. 5; and

FIG. 7 shows a transfer function for a second order sinc filter for use with the measurement circuit of FIG. 6, the inset curve showing details of the transfer function between 0 Hz and 500 Hz (x-axis) and −8 dB to 0 dB (y-axis).

### DETAILED DESCRIPTION

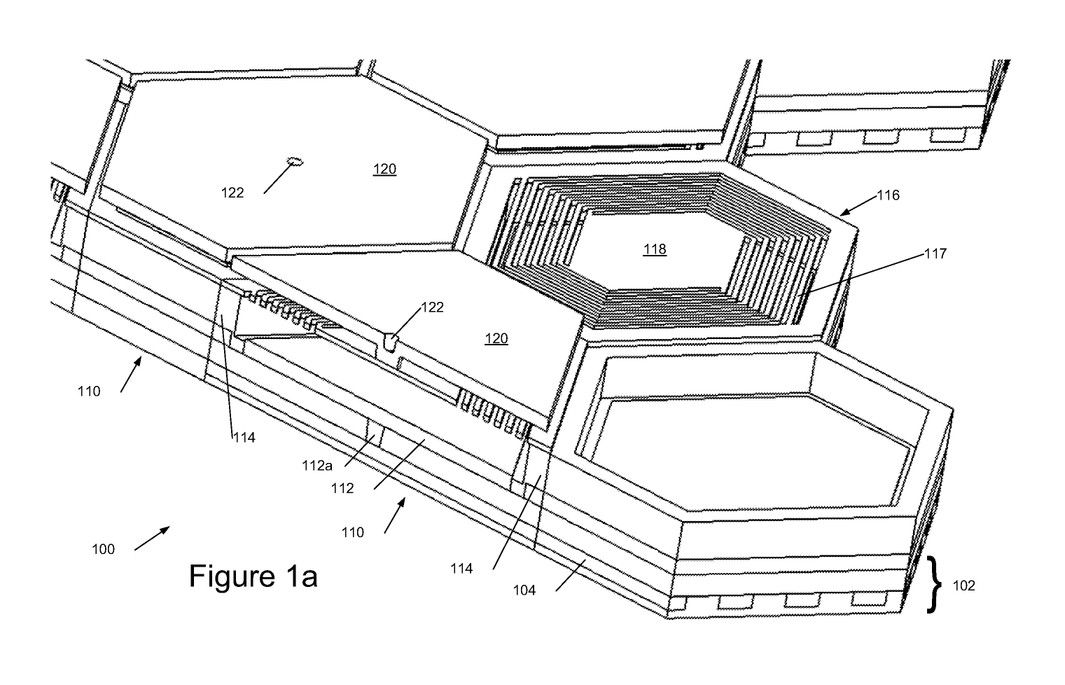

Referring first to FIG. 1, this shows a cutaway portion of an optical phase modulating MEMS SLM 100 prior to attaching a glass window over the MEMS pixels.

In the example of FIG. 1 each electrostatically-actuated pixel is approximately 10×10\sqrt{2} μm and deflects over 400 nm when actuated with 1 volts, has 8 nm of deflection resolution, settles within 30 μs, and has the shape of an irregular hexagon. The mirror spring comprises a single crystal silicon (SCS) electromechanical flexure serving as both a spring/mirror mount and as a top electrode.

Thus in some preferred embodiments the SLM 100 comprises a substrate 102 bearing a plurality of SLM pixels 110. For display devices, individual addressing of mirror actuators is generally desirable, and this may be achieved by incorporating CMOS circuitry underneath each actuator. Thus substrate 102 is preferably a CMOS substrate and a bottom pixel electrode 112 may comprise a portion of an exposed top metal layer of the CMOS substrate with a via 112a connection to one or more underlying metal layers 104 of the CMOS substrate.

A MEMS pixel 110 also comprises a spring support structure 114, as illustrated an oxide wall, around the perimeter of the bottom pixel electrode 112. The spring support structure 114 supports a mirror spring 116 comprising a mirror support 118 and a plurality of mirror spring arms 117 each extending between mirror support 118 and the spring support structure 114. In the preferred embodiment illustrated each mirror spring arm has a spiral shape. The mirror spring 116 is electrically conductive and acts as a second, top electrode of the MEMS pixel structure. In operation a voltage applied between the bottom 112 and top 116 pixel electrodes generates an electrostatic force which results in translation (piston-type motion) of the mirror support 118.

The pixel further comprises a mirror 120 mounted on the mirror support 118 and attached to this support by a ‘stitch’ or via (which leaves a dimple artefact 122 in the centre of the mirror). In embodiments the mirror spring 116 may optionally be attached to the substrate or spring support structure by another ‘stitch’ or via (not shown in FIG. 1). For example where the mirror spring comprises SiGe, the SiGe may be deposited into a trench extending down to the underlying silicon substrate.

When fabricating the structure of FIG. 1, the CMOS drive circuitry is constructed first and the MEMS actuator afterwards, and thus the MEMS fabrication should be compatible with CMOS, in particular processing temperature limitations (a maximum processing temperature of 425° C.). The mirror spring should exhibit good mechanical reliability and preferably its properties should not change significantly in 10¹⁰ or more cycles. Most metals and metal alloys do not satisfy these desirable requirements and whilst silicon based films such as polysilicon can exhibit this level of mechanical reliability, polysilicon requires high deposition temperatures which are incompatible with the CMOS temperature requirements.

Silicon (Si) germanium (Ge) alloys, in particular compositions having a high germanium content, for example greater than 65%, can have low deposition temperatures (down to 370° C.) and excellent mechanical properties that include low stress and low creep. High electrical conductivity can also be obtained with SiGe alloys, either with n-type or p-doping.

The preferred microstructure for mechanically reliable SiGe films is polycrystalline microstructure or a mixture of amorphous and crystalline phases. A preferred deposition method for deposition of SiGe films is chemical vapour deposition (CVD) from silane and germane. An alternative deposition method for these films is plasma enhanced chemical vapour deposition (PECVD). This can be performed at even lower deposition temperatures than CVD although the mechanical properties are not as favourable as for CVD films.

Electrostatic actuators using SiGe alloys as the functional material are compatible with fabrication of the CMOS substrate first, and also are able to provide the other desirable properties for display applications mentioned above. In one approach polycrystalline SiGe is deposited at, for example, 385° C. or less over a silicon seed layer (provided from a disilane deposited film). Optionally annealing such as laser annealing may be employed to reduce grain size and RMS roughness. Another less preferable option is to use polycrystalline germanium, which can self-anneal, but this material is less stable over time and also prone to attack by moisture. A further possibility is to employ an amorphous silicon mirror spring optionally again with a laser or low temperature annealing process.

For further details reference may be made to our co-pending US patent application Ser. No. ______ entitled “Spatial Light Modulators and Fabrication Techniques” and filed on the same day as the present application, which is hereby incorporated by reference in its entirety for all purposes.

### Example Holographic Image Projection System

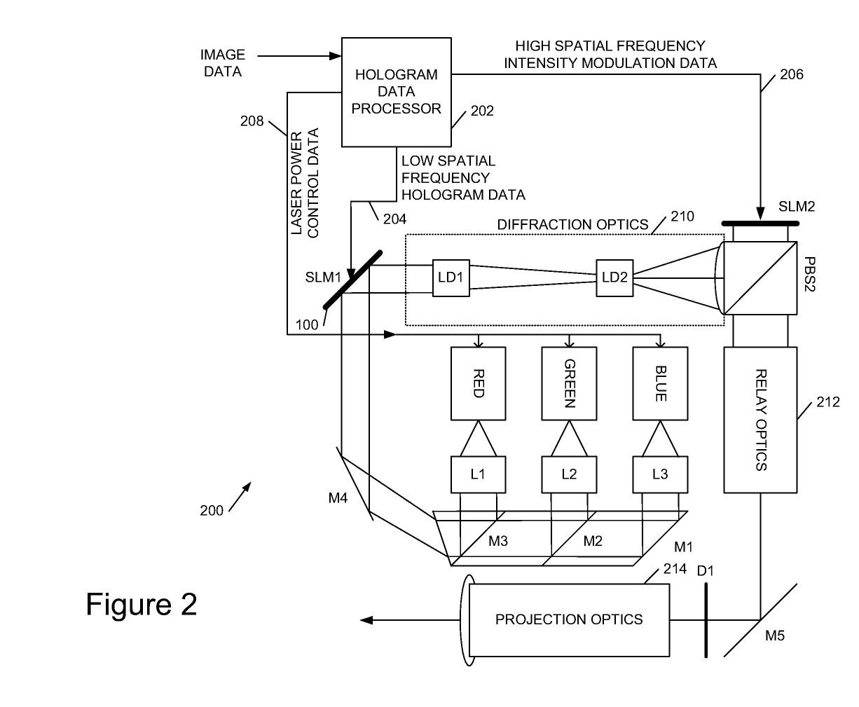

FIG. 2 shows an example holographic image projection system architecture 200 in which the SLM may advantageously be employed. The architecture of FIG. 2 uses dual SLM modulation—low resolution phase modulation and higher resolution amplitude (intensity) modulation. This can provide substantial improvements in image quality, power consumption and physical size. The primary gain of holographic projection over imaging is one of energy efficiency. Thus the low spatial frequencies of an image can be rendered holographically to maintain efficiency and the high-frequency components can be rendered with an intensity-modulating imaging panel, placed in a plane conjugate to the hologram SLM. Effectively, diffracted light from the hologram SLM device (SLM1) is used to illuminate the imaging SLM device (SLM2). Because the high-frequency components contain relatively little energy, the light blocked by the imaging SLM does not significantly decrease the efficiency of the system, unlike in a conventional imaging system. The hologram SLM is preferably be a fast multi-phase device, for example a pixellated MEMS-based piston actuator device.

In FIG. 2:
SLM1 is a pixellated MEMS-based piston actuator SLM as described above, to display a hologram—for example a 160×160 pixel device with physically small lateral dimensions, e.g <5 mm or <1 mm.
L1, L2 and L3 are collimation lenses (optional, depending upon the laser output) for respective Red, Green and Blue lasers.
M1, M2 and M3 are dichroic mirrors a implemented as prism assembly.
M4 is a turning beam mirror.
SLM2 is an imaging SLM and has a resolution at least equal to the target image resolution (e.g. 854×480); it may comprise a LCOS (liquid crystal on silicon) panel.
Diffraction optics 210 comprises lenses LD1 and LD2, forms an intermediate image plane on the surface of SLM2, and has effective focal length f such that fλ/Δ covers the active area of imaging SLM2. Thus optics 210 perform a spatial Fourier transform to form a far field illumination pattern in the Fourier plane, which illuminates SLM2.
PBS2 (Polarising Beam Splitter 2) transmits incident light to SLM2, and reflects emergent light into the relay optics 212 (liquid crystal SLM2 rotates the polarisation by 90 degrees). PBS2 preferably has a clear aperture at least as large as the active area of SLM2.
Relay optics 212 relay light to the diffuser D1.
M5 is a beam turning mirror.
D1 is a diffuser to reduce speckle.
Projection optics 214 project the object formed on D1 by the relay optics 212, and preferably provide a large throw angle, for example >90°, for angled projection down onto a table top (the design is simplified by the relatively low entendue from the diffuser).

The different colours are time-multiplexed and the sizes of the replayed images are scaled to match one another, for example by padding a target image for display with zeros (the field size of the displayed image depends upon the pixel size of the SLM not on the number of pixels in the hologram).

A system controller and hologram data processor 202, implemented in software and/or dedicated hardware, inputs image data and provides low spatial frequency hologram data 204 to SLM1 and higher spatial frequency intensity modulation data 206 to SLM2. The controller also provides laser light intensity control data 208 to each of the three lasers. For details of an example hologram calculation procedure reference may be made to WO2010/007404 (hereby incorporated by reference in its entirety for all purposes).

### MEMS Pixel Mirror Deflection Versus Voltage

Referring again to FIG. 1, downward deflection of the mirror is actuated by the electrostatic force across the capacitor gap, and the restoring force is provided by the elastic energy stored in the beams or arms of the supporting spring. The detailed response depends on mechanical details of the pixel construction but, broadly speaking, the mechanical restoring force is approximately linear with deflection and the electrostatic force is inversely proportional to the gap.

For a mirror supported by four rectangular mirror beams with potential V applied between the top, mirror-driving electrode and a fixed bottom electrode, it can be shown (see our co-pending US patent application entitled “Spatial Light Modulators and Fabrication Techniques” filed on the same day as this application) that the vertical deflection, z, of the pixel mirror may be approximated as follows:

$$V = \sqrt{\frac{8 {Ewt}^{3}}{ɛ {AL}^{3}}} ( h - z ) {z}^{1 / 2} \qquad ( 1 )$$

where E is the beam modulus of elasticity (for example 72 and 160 GPa for Al and (single crystal) Si, respectively), t, w, and L are the beam thickness, width, and length, respectively, A is the area of the capacitor and c is the permittivity of free space and h is the distance between the electrodes with no applied voltage.

The distance, d, between the top and bottom electrodes may be approximated as follows:

d=α₁−β₁V²+γ₁V⁴+ (2)

The actual response of a pixel 110 of the type shown in FIG. 12 is complicated because the top capacitor plate (electrode) includes the spring arms, and thus as the central, mirror-support portion of the mirror spring approaches the bottom electrode the effective area reduces. However the fringing fields around the spring arms act to increase the effective area of the top electrode. Further the mirror (top electrode) will generally have a small, potentially variable. Component of tip and/tilt in the x- and y-lateral directions (although this also has a quadratic response).

Nonetheless it has been found that the response is well approximated by just the first and second terms, and thus in embodiments calibration data for a MEMS SLM pixel may comprise just a small number of parameters, for example just α₁ and β₁.

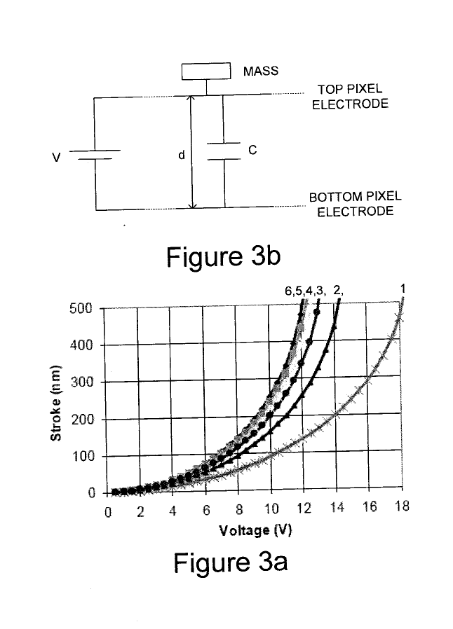

FIG. 3a shows an example set of curves of pixel mirror deflection (in nm) against voltage for a hexagonal MEMS pixel, illustrating the quadratic shape of the response curve. The example curves are for a mirror spring with mirror spring arms making a variable number of turns or loops of a spiral around the central mirror support, as illustrated at 0.5, 0.67, 0.83, 1.0, 1.5 and 2.0 loops for curves 1 through 6 respectively (where a loop is defined as a 360° rotation around the pixel perimeter). The deflection-voltage relationships are for an electrostatic gap of 1.8 μm.

From FIG. 3a it can be appreciated that a single parameter, β₁ in the above equation, is sufficient to characterise the curve. In general, each pixel of the SLM will have a different value of β₁.

FIG. 3b shows a model of a MEMS pixel in the structure of FIG. 1, where the mirror mounted on the spring/actuator is modelled as a mass, moved electrostatically by a voltage V applied across the pixel electrodes, which have a nominal separation d and capacitance C. This is a simplified model as from the cross-section of FIG. 1 it will be appreciated that under an applied electrostatic force the mirror support 118 moved towards the bottom pixel electrode but the outer ends of the spring arms remain in place where they are attached to the mirror support 118. Nonetheless the model of FIG. 3b is a useful approximation of the pixel behaviour. The capacitance is also a function of the x- and y-tip and tilt of the top pixel electrode (mirror support), but in embodiments of the device of FIG. 1 this is approximately static (for example <5° or)<1°.

In one illustrative example the MEMS SLM has a 144×144 array of active pixels, with each pixel size about 14 μm×10 μm. Each pixel mirror has maximum deflection of 400 nm with an absolute accuracy of +/−4 nm and an 8 nm step.

The total number of deflection levels may be less than 25 but the deflection is non-linear with the actuation voltage and thus with a linear D/A converter, a 7- or 8-bit D/A converter may desirable. The exact deflection vs. actuation voltage is determined by calibration, as described further below. In embodiments the maximum pixel electrode voltage applied may of order 10-12 volts.

The actual MEMS load is a very small capacitance of the pixel pad (less than 10 fF). The displacement charge in the pixel capacitance due to mechanical pump action can be estimated, for one example implementation of the MEMS SLM, by modelling as a parallel plate capacitor with 140 μm² plate area and a capacitor distance of 2 μm (going down to 1.6 μm for a 400 nm displacement) with a capacitance of about 0.15 fF. One difficulty with determining an accurate calibration is that of accurately measuring the very small charge on a pixel capacitor.

### MEMS SLM Calibration Techniques

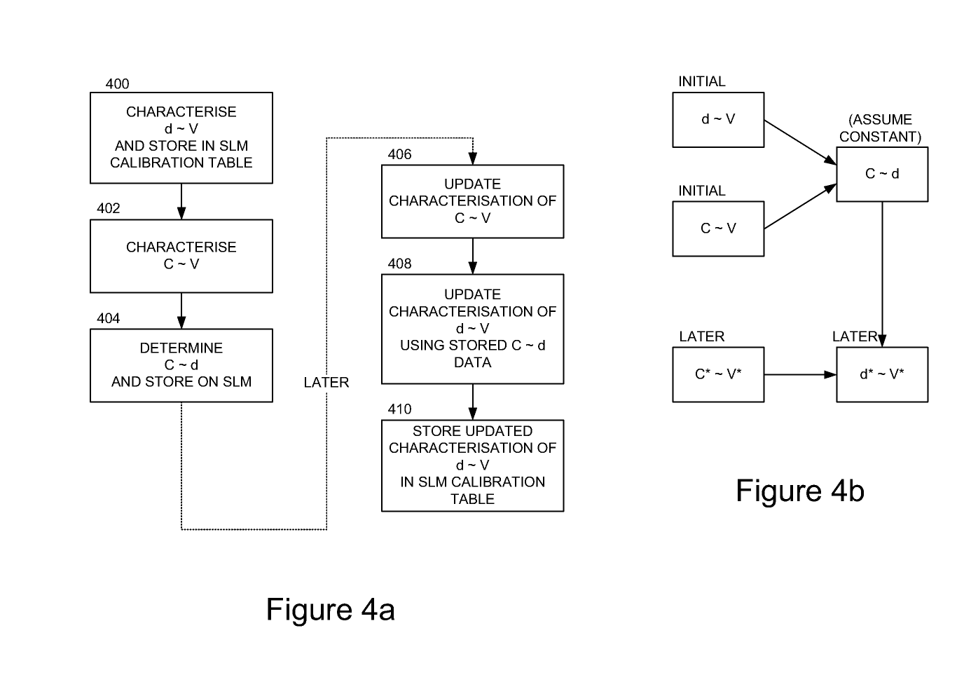

Referring now to FIG. 4a, in an embodiment of the procedure we describe there is an initial characterisation of top electrode distance/mirror displacement against applied voltage for each pixel of the SLM (step 400). This may be performed at the factory where the SLM is manufactured, and the characterising data is, in embodiments, stored in a table in non-volatile memory (for example, Flash memory) on the SLM. Calibration data is stored for each pixel of the SLM as the displacement-voltage response may vary from one pixel to the next. Preferably the distance/displacement is measured over a range of different voltages, but in embodiments the pixel response may be characterised by just one or two parameters, as described above.

The displacement of a mirror may be measured using one of a range of different techniques including, but not limited to, white light interferometry, laser Doppler interferometry, visual or electron microscopy, or other techniques. One example of another technique which may be employed is displaying a pattern, for example a phase gradient, on a portion of the SLM and determining the displacement of a diffracted spot, using this to determine the displacement of one or a group of pixels (similar techniques are described in our International patent application WO2010/109241, to which reference may be made). One advantage of the latter approach is that it potentially enables the pixel displacement to be measured after the SLM has been hermetically sealed under a cover window.

There is also an initial characterisation (step 402) of the capacitance-voltage response of each pixel. This may either be performed by measurement circuitry on the SLM (described later) or by external measurement apparatus. This calibration may also be performed where the device is manufactured; it will be appreciated that the order of steps 400 and 402 does not matter. Again preferably the capacitance of each pixel is measured at a plurality of different voltages over a voltage range, but the resulting data may be characterised by just one or two parameters characterising the curve of capacitance against voltage. For example, using the above nomenclature:

$$C = \frac{ɛ A}{d} ; \frac{1}{{α}_{2} - {β}_{2} {V}^{2}} \qquad ( 3 )$$

where α₂ and β₂ corresponds to α₁ and β₁ above, but have different values. Thus for each pixel there may be an initial determination of (α₁, β₁, α₂, β₂) or even just (β₁, β₂). The skilled person will appreciate that data defining a relationship between, for example, d and V may define either d as a function of V or vice versa.

The procedure then determines (step 404) a relationship between pixel electrode capacitance and electrode/mirror distance/displacement for each pixel, and also stores this data in non-volatile memory on the SLM. This is assumed to be constant for each pixel. It will be appreciated that the capacitance-distance relationship can be determined from the distance-voltage relationship and capacitance-relationship. This concludes the initial determination of data characterising the responses of the SLM pixels.

Then, at some later stage the data characterising the SLM pixels is updated using measurement circuitry on the SLM, and the updated characterising data is stored in the non-volatile memory of the SLM for subsequent use. Where the SLM is incorporated into a display system, preferably the updating of this calibration occurs whilst the display is in a quiescent state, for example as a background task.

In more detail, at step 406 measurement circuitry on the SLM is used to update the pixel capacitance-voltage characterisation of a pixel, and this information is then used, together with the stored capacitance-distance/displacement data, to update the distance/displacement-voltage characterising data for the pixel stored in a pixel calibration table in the non-volatile memory of the SLM (steps 408, 410). If we denote measurement made at a later time by an asterisk then, in embodiments, step 406 may determine values for α₂* and β₂* (or just β₂*), and these may in turn be used to determine updated values for α₁* and β₁*, to define d in terms of V using a version of equation (2). Alternatively a dual or complementary pair of parameters may be employed to define V in terms of d using a dual version of equation (2). It is generally preferable to store on the SLM characterisation data in a form which defines Vin terms of d, as in general the input data to the SLM will be in the form of data defining a desired mirror displacement of optical phase, and this is used to determine the analogue voltage to apply to a pixel electrode.

FIG. 4b expresses, pictorially, how the initially and later measured pixel characterising data d˜V and C˜V (where ˜ denotes a characterisation of one of the variables in terms of the other) is employed to determine a later, updated relationship between d* and V*.

This can also be expressed in more mathematical terms as shown below where, in principle, f denotes a potentially arbitrary function, although as previously discussed, it may be approximated by a simple, quadratic dependence characterised by one or two parameters:

d=f₁(V); V=f₁⁻¹(d) (4)

C=f₂(V); V=f₂⁻¹(C) (5)

Thus one can determine from the initial calibration:

d=f₃(C)=f₁(f₂⁻¹(C)); C=f₂(f₁⁻¹(d)) (6)

Data defining (6) is stored in non-volatile memory on the SLM. The later calibration determines:

C=f₂*(V); V=f₂*⁻¹(C) (7)

And substituting for C from (6):

V=f₂*⁻¹(f₂(f₁⁻¹(d)))=f₁*⁻¹(d) (8)

or

V=f₂*⁻¹(f₃⁻¹(d))=f₁*⁻¹(d) (9)

Data defining the updated V*˜d* relationship defined by equation (8), or equivalently equation (9), is then stored on the SLM to provide an updated pixel calibration V=f₁*⁻¹(d).

In embodiments of the procedure, optionally the above described functions may also be expressed as a function of temperature, in either numerical or analytic terms, or a set of functions may be employed one for each of a corresponding set of temperature ranges. Where a global correction of parameters for temperature is made, in a one preferred embodiment this uses digital temperature sensing circuitry with 0.5° C. per least significant bit resolution.

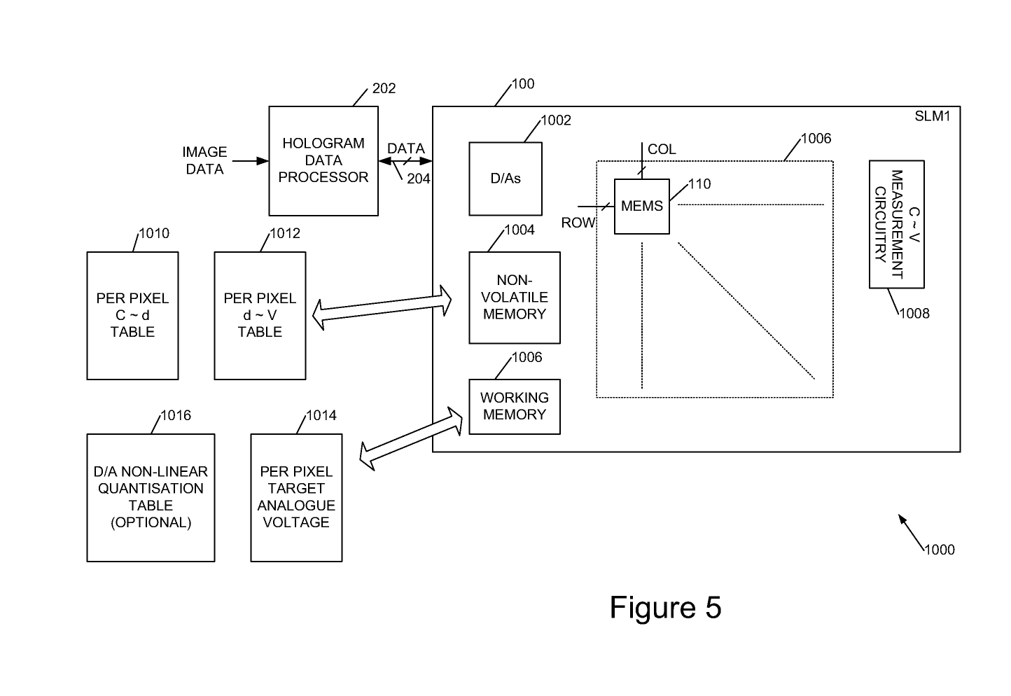

Referring now to FIG. 5, this shows a portion of the holographic image display system of FIG. 2, incorporating an optical phase modulating MEMS SLM 100 configured to implement the above described procedure. The MEMS SLM 100 comprises an active matrix pixel region 1006 and an adjacent area of CMOS substrate on which driver, interface and other circuitry is provided.

In more detail the additional circuitry on the same substrate as the active MEMS pixel array 1006 comprises, inter alia, one or more digital-to-analogue converters 1002 for providing an analogue voltage drive to the pixels (optionally the pixels may include one or more sample/hold circuits, as described in our co-pending application Ser. No. ______ ‘MEMS spatial light modulator pixel drive circuits’ filed on the same day as this application, which is hereby incorporated by reference in its entirety for all purposes), non volatile memory 1004, working memory 1006, and measurement circuitry 1008. The non-volatile memory 1004 stores, inter alia, a table 1010 of per pixel data characterising a relationship between a capacitance and top electrode distance or mirror displacement, and a second table 1012 characterising, for each pixel, a relationship between top electrode distance or mirror displacement and applied analogue voltage. This latter table is updated as a background task to maintain the holographic image display system in calibration. The working memory 1006 in one embodiment includes a matrix 1014 of target analogue voltage values for each pixel and, optionally, a corresponding matrix indicating a digital value to be applied to a D/A converter 1002 to achieve this analogue voltage, for each pixel. The measurement circuitry 1008, described later, is used to measure a capacitance-voltage characteristic for each pixel for updating the calibration.

The CMOS substrate of the SLM100 may also include data processing circuitry (not shown in FIG. 5) coupled to the non-volatile and working memory, to perform calculations for updating the calibration. Alternatively a processor in the hologram data processor may be employed, in which case data bus 204 may be bidirectional.

In use the SLM receives input data defining a mirror displacement or phase and uses the data defining V=f₁*⁻¹(d) in table 1012 to determine the analogue voltage which should be applied to a pixel. The analogue voltages for driving the pixels are stored in matrix 1014, and these are converted to, for example, a 6-bit value for driving the D/As 1002. If a D/A has an analytic non-linear response, for example a square law response, this may be taken into account at this point; if there is a more complex non-linear mapping a lookup table such table 1016 may be employed.

### C˜V Measurement

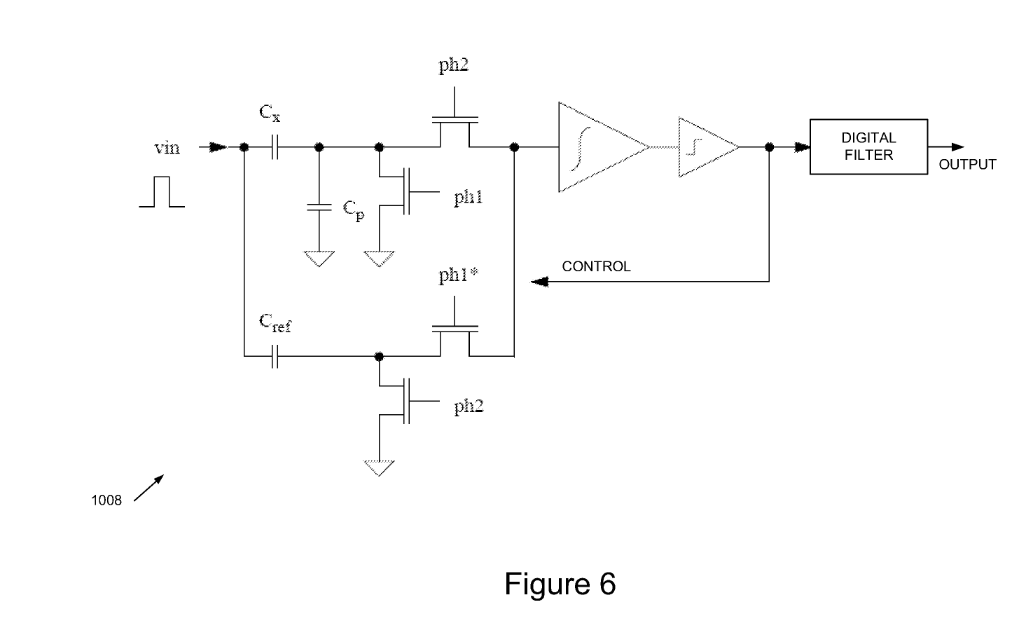

FIG. 6 shows a preferred embodiment of the measurement circuitry 1008 of FIG. 5, to perform a C˜V measurement on the MEMS pixels.

Due to mechanical actuation, the pixel capacitance, nominally about 1 fF, changes with the applied voltage on the pixel due to the mechanical displacement. The mechanical displacement may be about 20% of the total mechanical gap, so one can expect a total capacitance variation, which is inversely proportional to the gap, on the order of 250 aF or less. The absolute value of the capacitor may be influenced by unknown parasitics and could be as large as several fF. However, the voltage dependence of the pixel capacitance is mainly a function of the mechanical displacement, which is turn is a function of the applied voltage across this capacitor.

For a test mode, a 5 aFᵣₘₛ noise in capacitance measurement should be adequate to determine that the pixel is not stuck. However, for characterization purposes, a much finer C-V curve is useful in characterizing the actual MEMS structures. For this purpose a noise measurement under 0.5 aFᵣₘₛ is desirable. The noise measurement is preferably reduced by averaging over many cycles. Therefore a programmable measurement cycle time is useful. A measurement may be made over, for example, 10 ms (100K cycles).

The basic architecture of the circuit of FIG. 6 is a first-order sigma-delta modulator. The advantage of this architecture is that the measurement is inherently linear and the front end does the analog averaging to reduce the noise.

A square wave input vin, with programmable levels on the two phases of the clock ph1 and ph2 is used to charge and discharge the measured capacitor Cₓ. This capacitor is charged on ph1 and discharged into the integrator input during ph2. A large parasitic capacitor Cₚ will be present due to routing. However, this capacitor voltage returns to the analog reference level during both phases of the clock, therefore is not contributing any net charge in the integrator. A reference capacitor C_{ref} is used to subtract charge from the integrator during ph1, but this charge subtraction is controlled by the output of the output comparator. This feedback arrangement ensures that the integrator is not saturated and the duty cycle of the output 1-bit data stream represents the fractional ratio between the unknown capacitor Cₓ and the reference capacitor C_{ref}:

$${C}_{x} = {C}_{ref} \cdot \frac{{N}_{1}}{{N}_{T}}$$

where N₁ is the number of 1s and N_{T} is the total number of cycles.

The analog reference level may be about 1 V above ground. The reference level and the 2.5 V supply rail limit the maximum amplitude of the vin square wave. When determining a C-V characteristic, V is set with a D/A converter (not shown in FIG. 6). In embodiments a pixel capacitance is driven with a square wave between V and V+1 volt.

It is important to note that C_{ref} is charged/discharged from the same square waveform as the measured capacitor Cₓ. This circuit is therefore first order insensitive to the amplitude of the driving squarewave vin. The maximum value of the measured capacitor is limited by C_{ref}.

A large C_{ref} value will increase the quantization noise, especially at low oversampling ratios. Therefore in embodiments C_{ref} is chosen to be 32 fF.

The speed of the circuit is determined by the settling of the integrator stage and the settling of the squarewave input vin. It is advantageous to increase the clock frequency in order to reduce test time. However, the clock rate is currently limited by the settling of the MEMS driving network and if a clock frequency lower than 1 MHz may be preferable. Since the vin level is driven by a high-voltage circuit (12 V) with a programmable common-mode, that actually represents the pixel actuation voltage, clock frequencies above few MHz may be difficult to achieve.

To avoid limit cycles that can be quite strong in first order sigma-delta modulators, optional dithering of the comparator levels can be employed.

The vin squarewave should have a fixed amplitude of 1 Vpp and a common-mode level of 1 V, 2 V, up to 11 V. This is achievable with a simple 4-bit D/A converter.

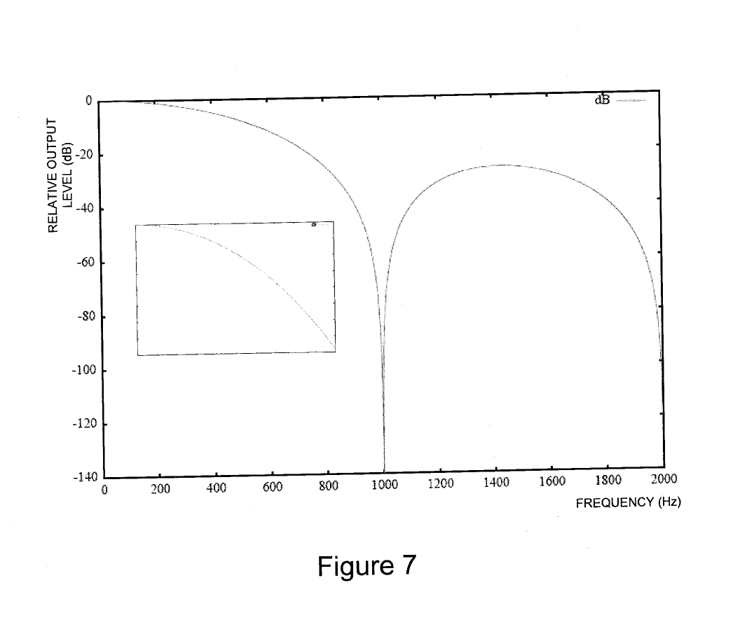

A digital low pass filter at the output of the circuit provides noise reduction and decimation to provide a multi-bit digital output. In embodiments a second order sinc filter is employed with a transfer function as shown in FIG. 7.

The 1-bit feedback sigma delta modulator is inherently linear. The total measurement error is dominated by thermal noise. The thermal noise at the integrator input will be largely dominated by the parasitic capacitance Cₚ. The total noise charge power, integrator over all frequencies, can be expressed as

Qnᵣₘₛ²=k·T·Cₚ

Assuming a certain peak-to-peak amplitude Aᵢₙ of the squarewave input, the equivalent noise in the capacitance measurement for a single clock cycle will be

$${Cxn}_{rms}^{2} = f \cdot \frac{{Qn}_{rms}^{2}}{{A}_{in}^{2}} = f \cdot \frac{k \cdot T \cdot {C}_{p}}{{A}_{in}^{2}}$$

where f is a noise factor due to the integrator noise, correlated double sampling, and the extra charge noise in the sampling phase, k is Boltzmann constant, and T is the absolute temperature. With Cₚ˜1 pF, Aᵢₙ˜1 Vₚₚ, f˜8, the capacitance noise is

Cxnᵣₘₛ; 200 aFᵣₘₛ

The equivalent integrator input referred noise is about 200 mVᵣₘₛ, which, in a total signal bandwidth of 500 KHz (Nyquist), is about 280 nVᵣₘₛ/sqrt(Hz). The integrator input referred noise density should be below 100 nVᵣₘₛ/sqrt(Hz).

The measurement noise can be reduced by averaging. To reach 0.5 aFᵣₘₛ noise limit, a 400× reduction in noise is needed, which requires ˜160,000 clock cycles. The clock decimation may be programmable between 2¹⁰ and 2¹⁷. Two consecutive samples at the decimated clock will be averaged after sinc filter settling. At the lower limit, the noise reduction is about sqrt(2¹¹)˜44.7×, so a measurement noise of about 4.47 aFᵣₘₛ, while at the upper limit, the noise reduction will be about sqrt(2¹⁸)˜500×, for a total measurement noise of under 0.4 aFᵣₘₛ. Additional noise reduction can be obtained by additional digital averaging.

The 1/f noise at the integrator input may be reduced by correlated double sampling. This approach also reduces the integrator input referred offset and drift.

The quantization noise is determined by the value of the C_{ref} capacitor and the oversampling ratio. Even with a minimum oversampling ratio of 2¹⁰, the equivalent quantization level is at least 93 dB below the C_{ref} value of 32 fF, so less than 1 aFᵣₘₛ. The quantization noise is much below the thermal noise.

The transfer function of the 2nd order sinc filter in the z-domain is

$$H ( z ) = {( \frac{1 - {z}^{- D}}{1 - {z}^{- 1}} )}^{2}$$

where z-¹ delay refers to the clock (1 MHz) rate. D is the decimator factor (1024 for the lower end).

A preferred implementation of this transfer function

$$\frac{1}{1 - {z}^{- 1}} \cdot \frac{1}{1 - {z}^{- 1}} \cdot ( 1 - {z}^{- D} ) \cdot ( 1 - {z}^{- D} )$$

uses two integrators for the denominator and two digital subtractors for the numerator. The subtractors use a divide by D clock (1 KHz) to implement also the decimation. The digital integrators are allowed to wrap around as long as they are wide enough. The width of the data bus must be at least

Nrep=ceil(2·log₂(D)+1)

where D is the decimator factor (for example 2¹⁷) and the factor of 2 is the order of the sinc filter. In this example The data bus width should be 35-bit for the highest decimation ratio.

The detail of the frequency domain transfer function (inset in FIG. 7) indicates a −3 dB corner of about 300 Hz for a clock of 1,024 KHz and a decimation factor of 2¹⁰, and the equivalent noise bandwidth is about 500 Hz. Thus the noise bandwidth reduction is about equal to the decimation factor, 2¹⁰ in this case.

The group delay of the second order sinc filter is equal to 2 decimated clocks. In an example with a 1,024 KHz main clock rate and a decimation factor of 2¹⁰, the decimated clock has a frequency of 1 KHz and a period of 1 ms; the response to an input step function is 2 ms, or two decimated clocks.

In this example the total test time assuming a 2¹⁰ oversampling ratio is about 4*2¹⁰˜4,000 clock cycles per measurement. Assuming 3 measurements are used per pixel, with 160 pixels/column, and 4 columns shared for each C-V measurement circuit, the total test time at 1 MHz clock will be about 8 seconds. This time could be reduced by: i) using a larger driving amplitude and programming a lower oversampling ratio, with a tighter value for C_{ref}, such that the quantization noise does not become dominant); ii) using a larger number of C-V measurement circuits; and/or iii) using a faster clock, if the MEMS pixels settle faster.

Thus, broadly speaking, we have described a method of compensating for long-term mechanical property changes in an analogue optical MEMS SLM. In embodiments the SLM comprises a plurality of piston-type actuation optical phase modulating pixels each having a mirror with a variable height determined by an analogue voltage applied to a corresponding pixel electrode. In embodiments the method comprises performing initial calibrations of the analogue displacement and pixel capacitance versus analogue voltage to determine a relationship between the pixel capacitance and analogue displacement, and then updating the displacement-voltage capacitance using the initial calibration data and a later calibration of the analogue voltage-capacitance characteristic of a pixel.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method of compensating for long-term mechanical property changes in an analogue optical MEMS SLM, wherein said SLM comprises a plurality of optical phase modulating pixels each comprising a mirror having a variable displacement determined by an analogue voltage applied to a pixel electrode of the pixel, the method comprising:
performing a first initial calibration, for each said pixel of said SLM, of the analogue displacement of said mirror resulting from a said analogue voltage applied to the pixel;
performing a second initial calibration, for each said pixel of said SLM, of a capacitance of said pixel electrode of the pixel resulting from a said analogue voltage applied to the pixel;
performing at least one later calibration after said first and second initial calibrations, for each said pixel of the SLM, of the capacitance of said pixel electrode of the pixel resulting from a said analogue voltage applied to the pixel;
updating, for each said pixel of said SLM, said calibration of said analogue displacement of said mirror resulting from said applied analogue voltage using said later calibration of said capacitance resulting from said applied analogue voltage; and
using said updated calibration to determine an optical phase modulation drive to said pixels of said SLM to compensate for said long-term mechanical property changes.

2. A method as claimed in claim 1 further comprising determining a relationship between said capacitance and said analogue displacement from said first and second initial calibrations, and using said later calibration of said capacitance resulting from said applied analogue voltage, in combination with said relationship between said capacitance and said analogue displacement from said first and second initial calibrations, to perform said updating of said calibration.

3. A method as claimed in claim 2 wherein said SLM comprises non-volatile memory, and measurement circuitry responsive to said analogue variable displacement of said mirror of a pixel, the method further comprising storing data derived from said first and second initial calibrations of said SLM in said non-volatile memory, using said measurement circuitry of said SLM to perform said later calibration, and storing data derived from said updating in said non-volatile memory.

4. A method as claimed in claim 3 wherein said mirror is mounted on a spring, wherein said analogue variable displacement comprises translation in a direction perpendicular to said substrate, and wherein said updating of said calibration comprises calibrating said analogue variable displacement to better than a 50 nm standard deviation displacement error.

5. A method as claimed in claim 4 further comprising inputting a phase data value defining an optical phase modulation for a pixel, determining an analogue voltage to apply to a said pixel electrode from said phase data value and said stored data in said non-volatile memory, and applying an analogue voltage responsive to said determined analogue voltage to said pixel electrode.

6. A method as claimed in claim 5 further comprising quantising said determined analogue voltage to provide digital representation of said determined analogue voltage, and converting said quantised digital representation of said determined analogue voltage to an analogue voltage to apply to a said pixel electrode.

7. A method as claimed in claim 6 further comprising measuring a temperature of said SLM using temperature measurement circuitry on said substrate, and compensating said determining of said analogue voltage to apply to a said pixel to define an analogue optical phase modulation by the pixel using a result of said temperature measuring.

8. A method of providing a holographic image display, the method comprising using said SLM to display holograms to reconstruct images for display; and compensating for long-term mechanical property changes in said SLM using the method of claim 1.

9. A method as claimed in claim 8 further comprising performing said further calibration whilst said holographic image display is in a standby mode of operation by determining an averaged signal from said pixel electrode responsive to said analogue variable displacement, averaged over a period of at least 1 ms.

10. An analogue optical MEMS spatial light modulator (SLM) comprising a substrate bearing plurality of optical phase modulating pixels, each of said phase modulating pixels comprising a pixel electrode and a mirror mounted on a hinge or spring to provide an analogue variable displacement in response to an analogue voltage applied to said pixel electrode with respect to a common electrode of said pixel, wherein said SLM further comprises measurement circuitry fabricated on said substrate and having a drive output configured to apply a signal to one of said pixel electrode and said common electrode, having an input to receive a signal from one of said pixel electrode and said common electrode, and having a pixel measurement output responsive to said analogue variable displacement.

11. An analogue optical MEMS SLM as claimed in claim 10 wherein said measurement circuitry is configured to measure a capacitance between said pixel electrode and said common electrode.

12. An analogue optical MEMS SLM as claimed in claim 11 wherein said SLM further comprises calibration circuitry to determine, for each said pixel, a variation of said capacitance with said analogue voltage applied to said pixel electrode.

13. An analogue optical MEMS SLM as claimed in claim 12, further comprising non-volatile memory configured to store initial calibration data defining, for each said pixel, a relationship between said analogue variable displacement and a capacitance of the pixel, and wherein said SLM further comprises data processing circuitry configured to determine from said initial calibration data and said variation of said capacitance with said analogue voltage applied to said pixel electrode determined by said measurement, updated calibration data for each pixel defining an updated relationship between said analogue displacement and said applied analogue voltage, and to store said updated calibration data in said non-volatile memory.

14. An analogue optical MEMS SLM as claimed in claim 13 wherein said initial calibration data comprises first initial calibration data, for each said pixel, defining the analogue displacement of said mirror resulting from a said analogue voltage applied to the pixel, and second initial calibration data, for each said pixel, defining an initial variation of said capacitance with said analogue voltage applied to said pixel electrode.

15. An analogue optical MEMS SLM as claimed in claim 10 wherein said mirror is mounted on a spring, and wherein said analogue variable displacement comprises translation in a direction perpendicular to said substrate.

16. A holographic image display system comprising an analogue optical MEMS SLM as claimed in claim 15 and a system to display one or more holograms on said SLM to reconstruct images for display.

17. A method of compensating for long-term mechanical property changes in a diffractive image display using an analogue optical MEMS spatial light modulator (SLM), said MEMS SLM comprising a substrate bearing a plurality of optical phase modulating pixels, each of said phase modulating pixels comprising a pixel electrode and a mirror mounted on a hinge or spring to provide an analogue variable displacement in response to an analogue voltage applied to said pixel electrode; the method comprising:
performing an initial calibration of said SLM to determine a relationship between an analogue voltage applied to a said pixel electrode and said analogue variable displacement;
displaying a plurality of diffraction patterns on said SLM to diffractively display a plurality of images;
performing a further calibration of said SLM to update said relationship between said analogue voltage applied to a said pixel electrode and said analogue variable displacement; and
displaying a further plurality of diffraction patterns on said SLM to diffractively display a further plurality of images using said updated relationship between said analogue voltage applied to a said pixel electrode and said analogue variable displacement.

18. A method as claimed in claim 17 comprising performing said initial and said further calibrations for each said phase modulating pixel of said SLM.

19. A method as claimed in claim 18 wherein said mirror is mounted on a spring;
wherein said analogue variable displacement comprises translation in a direction perpendicular to said substrate;
wherein said displaying comprises controlling said analogue variable displacement to better than a 50 nm standard deviation displacement error; and wherein said displaying of a further plurality of diffraction patterns on said SLM comprises displaying at least 10⁶ said diffraction patterns.

20. A method as claimed in claim 19 comprising performing said further calibration whilst said diffractive image display is in a standby mode of operation by determining an averaged signal from said pixel electrode responsive to said analogue variable displacement, averaged over a period of at least 1 ms.

21. A method as claimed in claim 17 wherein said SLM comprises non-volatile memory and measurement circuitry responsive to said analogue variable displacement of said mirror of a pixel, the method further comprising storing data derived from said first and second initial calibrations of said SLM on said non-volatile memory, using said measurement circuitry of said SLM to perform said further calibration, and storing data derived from said updating in said non-volatile memory; and wherein said displaying of a said diffraction pattern on said SLM comprises inputting a phase data value defining an optical phase modulation for a pixel, determining an analogue voltage to apply to a said pixel electrode from said phase data value and said data stored in said non-volatile memory, and applying an analogue voltage responsive to said determined analogue voltage to said pixel electrode.

22. A method as claimed in claim 21 further comprising quantising said determined analogue voltage to provide digital representation of said determined analogue voltage, and converting said quantised digital representation of said determined analogue voltage to an analogue voltage to apply to a said pixel electrode.

23. A method as claimed in claim 21 further comprising measuring a temperature of said SLM using temperature measurement circuitry on said substrate, and compensating said determining of said analogue voltage to apply to a said pixel to define an analogue optical phase modulation by the pixel using a result of said temperature measuring.
